(19) United States
(12) Patent Application Publication
(10) Pub. No.: US 2004/0144214 A1
(43) Pub. Date: Jul. 29, 2004

(54) Sockets and method of surface treatment for sockets

(76) Inventor: Peng Ying-Hao, Tanzih (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/694,662

(22) Filed: Oct. 28, 2003

(30) Foreign Application Priority Data
Jan. 24, 2003 (TW) 092101765

(51) Int. Cl. B25B 13/00

(52) U.S. Cl. 81/124.6; 81/900

(57) ABSTRACT

A socket has a dark colored outer surface and a specification is rolled in the outer surface of the socket and coated with a brighter colored electroplating. The method for the surface treatment of the socket includes step of rolling an specification in an outer surface of the socket; step of electroplating the socket with a light colored layer of electroplating; step of removing the light colored layer of electroplating from the outer surface of the socket, and step of coating a dark colored layer on the outer surface of the large section and the specification is not included. By the surface treatment, the specification is obvious from the dart colored outer surface of the socket.

### FIELD OF THE INVENTION

The present invention relates to a socket and a method of surface treatment for sockets. The specification is rolled in the surface and displayed in a light-colored layer of electroplating and the rest of the surface of the socket is displayed in black.

### BACKGROUND OF THE INVENTION

A conventional socket 50 is shown in FIG. 1 and generally includes a large section 52 and a small section 51 and a passage 53 is defined through the socket 50. The specification 54 is rolled in the outer surface of the large section 52 and the whole socket 50 is proceeded with electroplating such that a light-colored layer of electroplating 60 is coated to the inner surface and outer surface side of the socket 50. Nevertheless, the specification is not obvious because there is no difference between the color of the specification 54 and the outer surface of the socket 50. Another surface treatment is to merge the socket in solution of Manganese Phosphite and this makes the surface to be dark. The inherent shortcoming of the above mentioned problem is not improved. Some of the specification is printed on the outer surface of the socket, although different colors can be used to the specification, it tends to be worn out.

The present invention intends to provide a method for making the specification of the socket is brighter than the color of the outer surface of the socket so that the specification can be seen clearly.

### SUMMARY OF THE INVENTION

The present invention relates to a socket and a method for surface treatment of a socket. The method comprises step of rolling a specification in an outer surface of the large section; step of electroplating the socket with a light colored layer of electroplating; step of removing the light colored layer of electroplating from the outer surface of the large section, and step of coating a dark colored layer on the outer surface of the large section and the specification being excluded.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow chart of the method of the present invention;

FIG. 2 is a perspective view to show the socket of the present invention;

FIG. 3 is a cross sectional view to show a layer of electroplating is coated to the socket;

FIG. 4 is a cross sectional view to show the layer of electroplating is removed from the outer surface of the large section of the socket;

FIG. 5 is a cross sectional view to show that a dark layer is coated on the outer surface of the large section of the socket;

FIG. 6 shows a protection layer is coated on the dark layer on the large section of the socket, and

FIG. 7 is a cross sectional view to show a conventional socket.

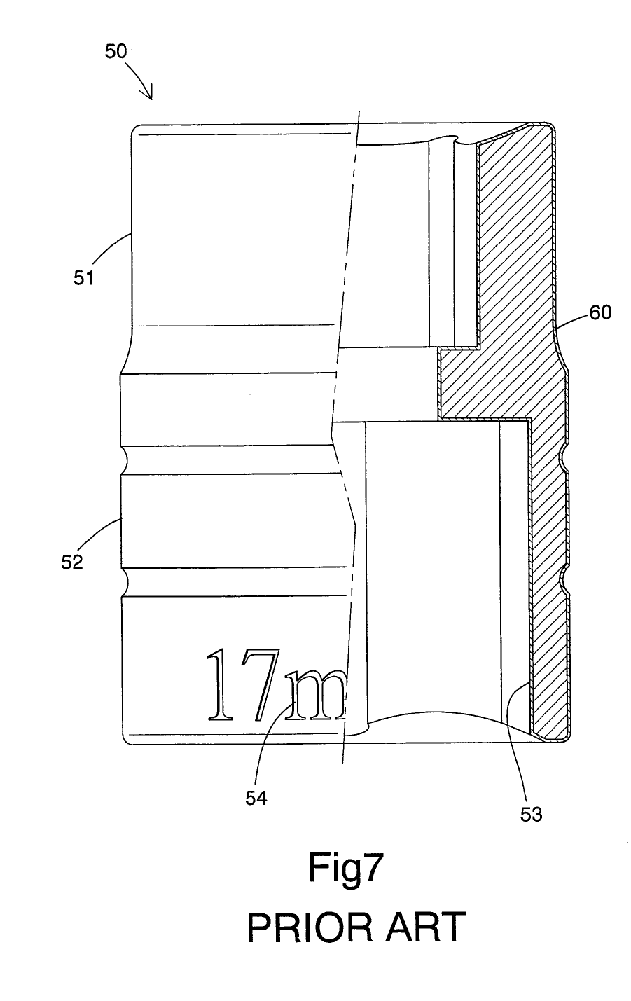

### DETAILED DESCRIPTION OF THE PREFERRED EMBODIMENT

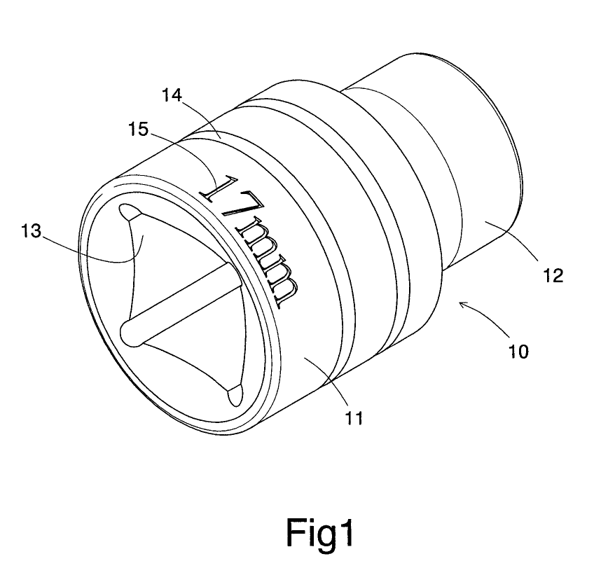

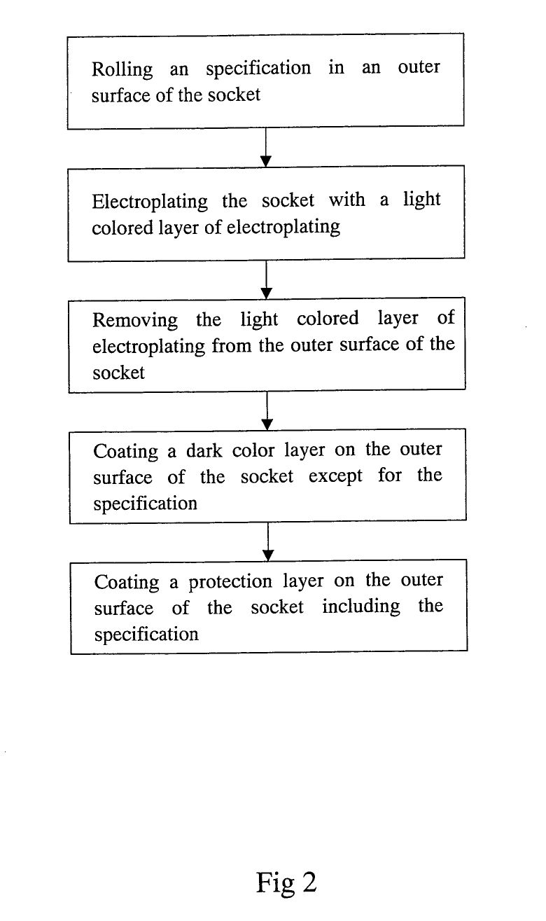

Referring to FIGS. 1 and 2, the socket 10 of the present invention comprises a body having a large section 11 and a small section 12. A passage 13 is defined through the body and two grooves 14 are defined in an outer periphery of the large section 11. An outer surface of the large section 11 is a dark colored surface and a specification 15 rolled in the outer surface of the large section 11 is coated with a brighter colored electroplating, such that the specification can be seen clearly.

A method for making the light colored specification 15 in the outer surface of a socket 10 includes:

step of rolling the specification 15 in the outer surface of the large section 11;

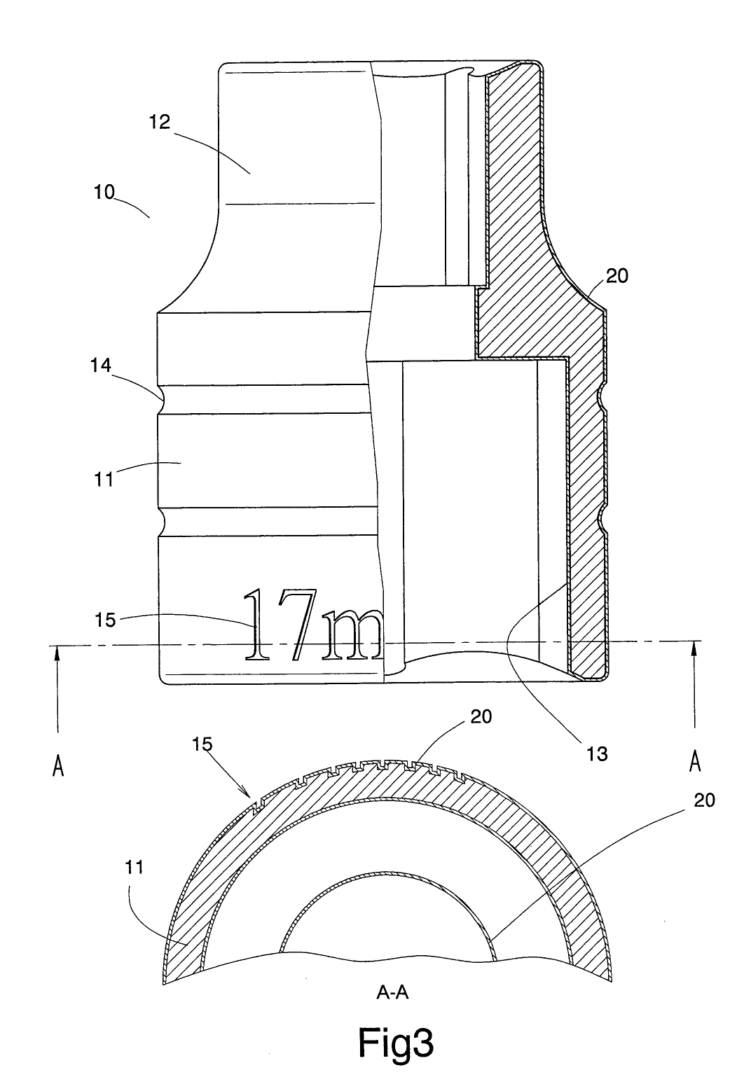

step of electroplating the socket 10 with a light colored layer of electroplating 20 as shown in FIG. 3;

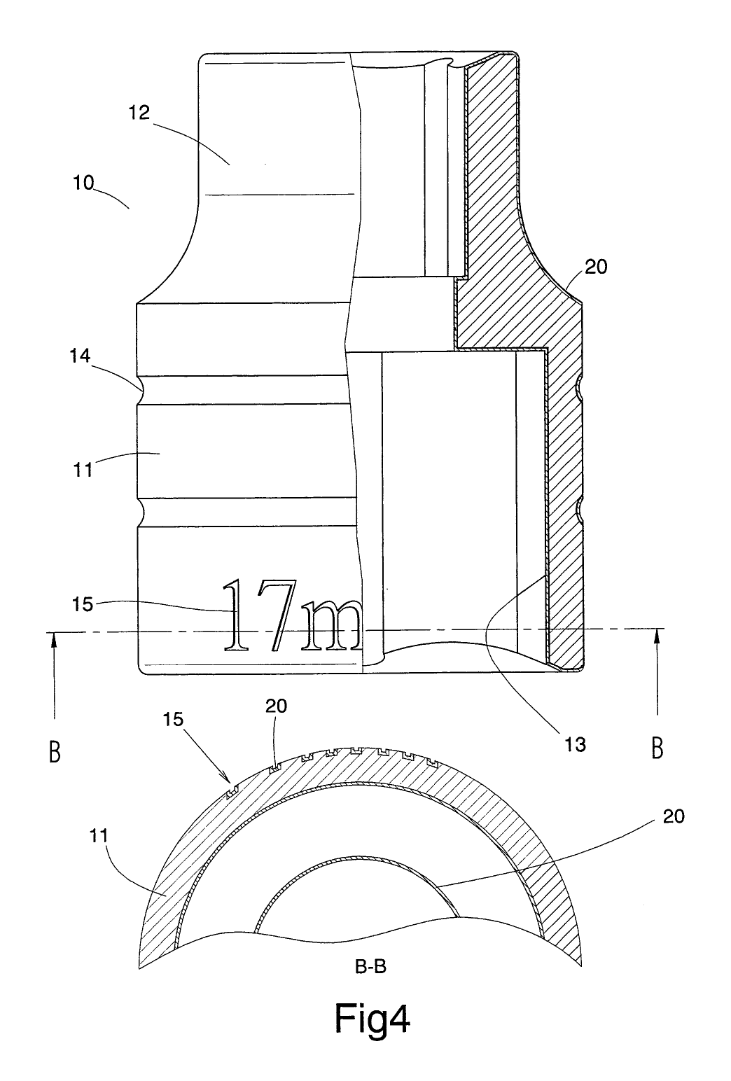

step of removing the light colored layer of electroplating 20 from the outer surface of the large section 11 as shown in FIG. 4;

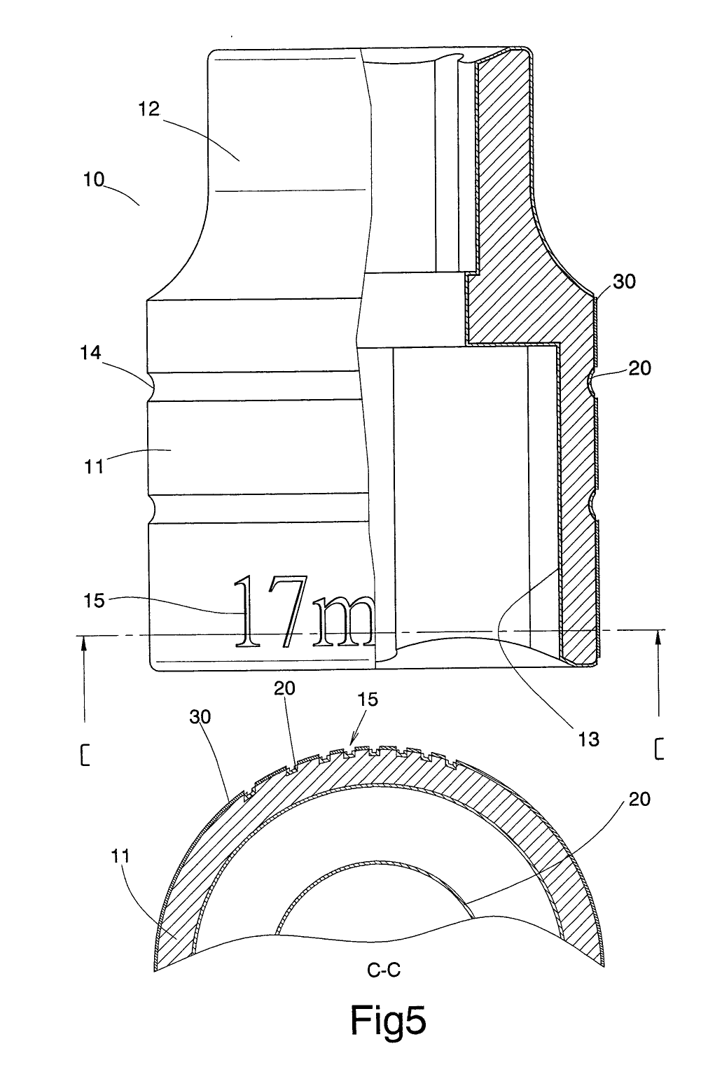

step of coating a dark colored layer 30 on the outer surface of the large section 11 by immerging the socket 10 into a solution of Manganese Phosphite while the specification being separated from the solution, as shown in FIG. 5, and

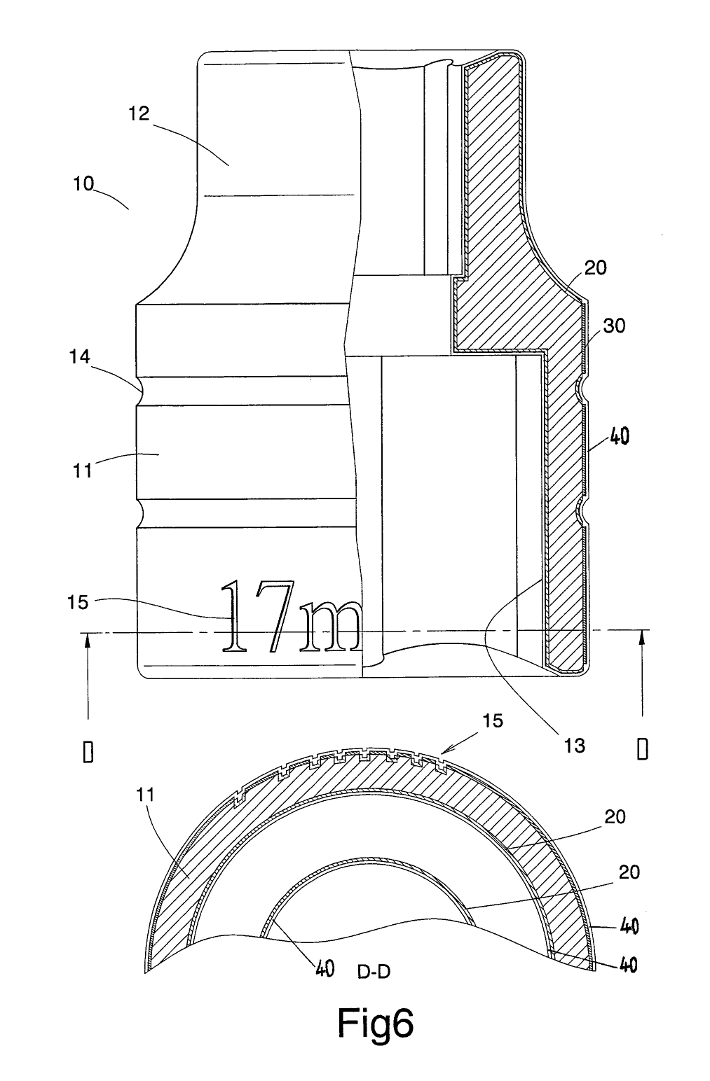

step of coating a protection layer 40 on the outer surface of the large section 11 and the specification 15 as shown in FIG. 6.

By the surface treatment, the bright colored specification 15 of the socket 10 is obvious from the dark colored large section of the socket 10.

While we have shown and described the embodiment in accordance with the present invention, it should be clear to those skilled in the art that further embodiments may be made without departing from the scope of the present invention.

What is claimed is:

1. A socket comprising:
a body having a passage defined through the body, an outer surface of the body being a dark colored surface and a specification being rolled in the outer surface of the body, the specification being coated with a brighter colored electroplating.

2. The socket as claimed in claim 1 further wherein a protection layer is coated on the outer surface of the socket including the specification.

3. The socket as claimed in claim 1, wherein the socket includes a large section and a small section, the specification being rolled in the outer surface of the large section, at least one groove defined in the outer surface of the large section.

4. A method for surface treatment of a socket, the method comprising:
step of rolling an specification in an outer surface of the socket;
step of electroplating the socket with a light colored layer of electroplating;
step of removing the light colored layer of electroplating from the outer surface of the socket, and
step of coating a dark colored layer on the outer surface of the socket except for the specification.

5. The method as claimed in claim 4 further comprising a step of coating a protection layer on the outer surface of the socket including the specification after the step of coating a dark colored layer.

6. The method as claimed in claim 4, wherein the dark colored layer is made by immerging the socket into a solution of Manganese Phosphite.
